(19) United States
(12) Patent Application Publication
(10) Pub. No.: US 2025/0328604 A1
(43) Pub. Date: Oct. 23, 2025

(54) LINEAR REGRESSION WITH HARDWARE CONSTRAINTS

(71) Applicant: Analog Devices, Inc., Wilmington, MA (US)

(72) Inventors: Abdullah Shamil Hashim Al Dujaili, Shrewsbury, MA (US); Tao Yu, Needham Heights, MA (US)

(21) Appl. No.: 19/186,421

(22) Filed: Apr. 22, 2025

Related U.S. Application Data
(60) Provisional application No. 63/637,281, filed on Apr. 22, 2024.

(51) Int. Cl. G06F 17/18

(52) U.S. Cl. CPC G06F 17/18

(57) ABSTRACT

Linear regression data may describe the processing task with a target vector describing an output of the hardware component, a measurement vector describing measurements on which the output of the hardware component is based, and a weight vector describing weights applied to the measurement vector to generate the target vector. The linear regression data may be modified to describe the processing task based on the target vector, the measurement vector, the weight vector, and a binary constraint vector describing a hardware constraint limiting access by the hardware component to at least a portion of the weight vector. The modified linear regression data may be relaxed based on a relaxed constraint vector that is based at least in part on the binary constraint vector. A convex solver algorithm may be used to determine a set of values for the weight vector and a set of values for the binary constraint vector.

### RELATED APPLICATION

The present application claims the benefit of U.S. Provisional Patent Application Ser. No. 63/637,281 filed on Apr. 22, 2024, which is hereby incorporated by reference herein in its entirety.

### FIELD OF THE DISCLOSURE

The present disclosure generally relates to electronics, and more particularly to configuring hardware blocks (e.g., digital predistortion (DPD) hardware for linearization of power amplifier) using model architecture search techniques (e.g., neural architecture search (NAS)).

### BACKGROUND

Radio frequency (RF) systems are systems that transmit and receive signals in the form of electromagnetic waves in the RF range of approximately 3 kilohertz (kHz) to 300 gigahertz (GHz). RF systems are commonly used for wireless communications, with cellular/wireless mobile technology being a prominent example, and may also be used for cable communications, such as cable television.

Many RF systems include power amplifier (PA) circuits for amplifying the signal prior to transmission, for example, via the antenna, coaxial cable, and/or the like. In some examples, allowing a PA circuit to operate including in its nonlinear (e.g., gain compression) region can provide one or more benefits, such as to improve amplifier efficiency and performance, reduce power consumption, reduce waste heat generation, and reduce or avoid the need for active or passive cooling of the PA circuit. When a PA circuit is operated in its nonlinear region, however, it may introduce undesired nonlinear distortions into the transmitted signal. PA outputs with nonlinear distortions can result in reduced modulation accuracy (e.g., reduced error vector magnitude (EVM)) and/or out-of-band emissions. Therefore, both wireless RF systems (e.g., Long Term Evolution (LTE) and millimeter-wave or 5th generation (5G) systems) and cable RF systems may have guidelines for PA linearity.

Digital predistortion (DPD) can be applied to enhance linearity of a PA, such as a PA operated in its nonlinear region. DPD may involve applying, in the digital domain, predistortion to a signal to be provided as an input to a PA to reduce and/or cancel distortion that is expected to be caused by the PA. The predistortion can be characterized by a PA model. The PA model can be updated based on the feedback from the PA (i.e., based on the output of the PA). The more accurate a PA model is in terms of predicting the distortions that the PA will introduce, the more effective the predistortion of an input to the PA may be in reducing the effects of the distortion caused by the amplifier.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A provides a schematic block diagram of an example radio frequency (RF) transceiver.

FIG. 1B provides a schematic block diagram of an example indirect learning architecture-based DPD.

FIG. 1C provides a schematic block diagram of an example direct learning architecture-based DPD.

FIG. 2A provides an illustration of a scheme for offline training and online adaptation and actuation for an indirect learning architecture-based DPD, according to some examples of the present disclosure.

FIG. 2B provides an illustration of offline training and online adaptation and actuation for a direct learning architecture-based DPD, according to some examples of the present disclosure.

FIG. 3 provides an illustration of an example implementation for a lookup table (LUT)-based DPD actuator circuit, according to some examples of the present disclosure.

FIG. 4 provides an illustration of an example implementation for a LUT-based DPD actuator circuit, according to some examples of the present disclosure.

FIG. 5 provides an illustration of an example implementation for a LUT-based DPD actuator circuit, according to some examples of the present disclosure.

FIG. 6 is a flowchart showing one example of a process flow that may be executed, in various examples, to arrange a hardware component to implement an operation.

FIG. 7 is a diagram showing one example form of linear regression data describing a processing task.

FIG. 8 is a block diagram of an example machine upon which any one or more of the techniques (e.g., methodologies) discussed herein may be performed.

### DESCRIPTION

The systems, methods and devices of this disclosure each have several innovative examples, no single one of which is solely responsible for all of the desirable attributes disclosed herein. Details of one or more implementations of the subject matter described in this specification are set forth in the description below and the accompanying drawings.

Challenges of linearity may be pronounced for PA s because such amplifiers may produce relatively high levels of output power, making PAS susceptible to entering certain operating conditions, such as saturation or gain compression. Nonlinear behavior of semiconductor materials used to form amplifiers may tend to worsen when the amplifiers operate on signals with high power levels relative to the bias and conditions of the PA (an operating condition commonly referred to as “operating in saturation”). This may increase the amount of nonlinear distortions in the PA output signals. On the other hand, amplifiers operating at relatively high power levels (i.e., operating in saturation) also typically function at their highest efficiency. As a result, linearity and efficiency (or power level) are two performance parameters for which, often, an acceptable trade-off has to be found in that an improvement in terms of one of these parameters comes at the expense of the other parameter being suboptimal. To that end, PA circuits may be designed with “back-off.” For example, the input power may be reduced in order to realize a desired output linearity (e.g., back-off may be measured as a ratio between the input power that delivers maximum power to the input power that delivers the desired linearity). Thus, reducing the input power may provide an improvement in terms of linearity but result in a decreased efficiency of the amplifier.

DPD can pre-distort an input to a PA to reduce and/or cancel distortion caused by the amplifier. To realize this functionality, at a high level, DPD involves forming a model of how a PA may affect an input signal, the model defining coefficients of a filter to be applied to the input signal (such coefficients referred to as “DPD coefficients”) in an attempt to reduce and/or cancel distortions of the input signal caused by the amplifier. In this manner, DPD will try to compensate for the amplifier applying an undesirable nonlinear modification to the signal to be transmitted, by applying a corresponding modification to the input signal to be provided to the amplifier.

Models used in DPD algorithms are typically adaptive models, meaning that they are formed in an iterative process by gradually adjusting the coefficients based on the comparison between the data that comes into the input to the amplifier and the data that comes out from the output of the amplifier. Estimation of DPD coefficients is based on acquisition of finite sequences of input and output data (i.e., input to and output from a PA), commonly referred to as “captures,” and formation of a feedback loop in which the model is adapted based on the analysis of the captures. More specifically, conventional DPD algorithms are based on General Memory Polynomial (GMP) models that involve forming a set of polynomial equations commonly referred to as “update equations,” and searching for suitable solutions to the equations, in a broad solution space, to update a model of the PA. For example, DPD algorithms may determine, from a set of observations, the causal factors that produced these observations.

In some examples, the GMP model for DPD algorithms can be expressed as a linear regression problem. For example, the target output of the DPD circuit (e.g., the pre-distortion to be applied to the input signal) may be expressed in terms of a measurement vector and a weight vector. The measurement vector may comprise measured outputs of the PA. The weight vector may describe weights to be applied to the measurements to generate the DPD output.

Solving inverse problems in the presence of nonlinear effects can be challenging. For example, GMP-based PA models may have limitations due to signal dynamics and limited memory depth required to store polynomial data, especially in the presence of the ever-increasing sampling rates used in state-of-the-art RF systems. In practice, a PA circuit including a DPD circuit may be subject to hardware constraints. For example, the PA circuit may be subject to limitations in memory, for lookup tables (LUTs) and/or the like. As a result, less than all values of the weight vector may be available to a DPD circuit. Solving the GMP model of the DPD circuit considering the hardware constraints may add complexity and challenge.

Similar hardware constraints may be encountered by hardware components implementing other operations based on linear regression. Examples include medical image processing, and the like.

Various examples described herein address these and other challenges, for example, using a model that expresses a linear regression as a mixed integer problem. For example, the weight vector may be expressed in terms of a raw weight vector and a binary constraint vector. For example, the weight vector may be expressed as the element-wise product or Hadamard product of the raw weight vector and the binary constraint vector. The binary constraint vector may include values of one or zero, where ones correspond to values of the weight vector that are accessible in view of hardware constraints. The mixed integer representation may be relaxed. For example, it may be expressed as a continuous constraint vector. For example, values of the continuous constraint vector may be any value from zero to less than or equal to one. A convex solver algorithm may be applied to the relaxed mixed integer representation to solve for the weight vector in view of the constraints. The solution may be used to program the hardware component (e.g., DPD circuit, medical imaging device, and/or the like) to execute the operation based on the linear regression. In some examples, the solution (e.g. constraint vector) generated using the convex solver algorithm may be projected back to a binary counterpart such as, by using randomization, rounding, and/or the like. Also, in some examples, the constraint vector generated by the convex solver algorithm may be binary or nearly binary such that projection to binary is not performed.

The examples described herein may be implemented, for example, to execute DPD for amplifiers (such as, but not limited to, PAs) for RF systems (such as, but not limited to, wireless RF systems of millimeter-wave/5G technologies). While examples of the present disclosure describe techniques for applying linear regression to implement a DPD arrangement for linearizing a power amplifier at an RF transceiver, the techniques disclosed herein are suitable for use in optimizing configurations for any suitable hardware block and/or subsystem.

According to an aspect of the present disclosure, a computer-implemented system may implement a method for programming or arranging a hardware component to perform an operation that may include a certain data transformation, for example, based on a linear regression. The data transformation can include linear and/or nonlinear operations and may generally include operations that change the representation of a signal from one form to another form. The hardware component may include a pool of processing units that can perform at least arithmetic operations and/or signal selection operations (e.g., multiplexing and/or de-multiplexing). The model architecture search may be performed over a search space including the pool of processing units and associated capabilities, a desired hardware resource constraint, and/or hardware operations associated with the data transformation. The model architecture search may also be performed to achieve a certain desired performance metric associated with the data transformation, for example, to minimize an error metric associated with the data transformation.

As used herein, the pool of processing units may include, but is not limited to, digital hardware blocks (e.g., digital circuits including combinational logics and gates), general processors, digital signal processors, and/or microprocessors that execute instruction codes (e.g., software and/or firmware), analog circuits, application specific integrated circuits (ASICs), field programmable gate arrays (FPGAs), etc. In general, a processing unit (or simply a hardware block) may be a circuit with defined inputs, outputs, and/or control signals. Further, multiple processing units (e.g., circuit blocks) can be connected in a defined way to form a subsystem to perform a data transformation, for example, including a sequence of transformations. The hardware configuration optimization can be performed at a functional level (e.g., with input-output correspondences) and/or at a subsystem level (e.g., including a sequence of operations).

To perform the model architecture search, the computer-implemented system may receive information associated with the pool of processing units. The received information may include hardware resource constraints, hardware operations, and/or hardware capabilities associated with the pool of processing units. The computer-implemented system may further receive a data set associated with the data transformation operation. The data set may be collected on the hardware component and may include input data, output data, control data, etc. The computer-implemented system may utilize the data to determine a hardware-constrained linear regression model to be implemented by a DPD circuit.

In some examples, the computer-implemented system may include memory storing instructions and one or more computer processors, where the instructions, when executed by the one or more computer processors, cause the one or more computer processors to determine and/or implement the linear regression described herein. In other examples, the model architecture search method may be in the form of instructions encoded in a non-transitory computable-readable storage medium that, when executed by one or more computer processors, cause the one or more computer processors to perform the method.

In some examples, an apparatus may be a DPD apparatus for pre-distorting an input signal to a nonlinear electronic component (e.g., a PA). For example, the input signal received at the input node may correspond to the input signal for the nonlinear electronic component and the first signal may correspond to a pre-distorted signal. The apparatus may further include a memory to store, based on the first model and DPD coefficients, one or more lookup tables (LUTs) associated with one or more nonlinear characteristics of the nonlinear electronic component. The apparatus may further include a DPD block including the first subset of the processing units. For DPD actuation, the first subset of the processing units may select first memory terms from the input signal based on the first model. The first subset of the processing units may further generate the pre-distorted signal based on the one or more LUTs and the selected first memory terms. In some examples, the first subset of the processing units may further select, based on the first model, second memory terms from a feedback signal associated with an output of the nonlinear electronic component. The control block may further configure, based on the first model, a second subset of the processing units to execute instruction codes to calculate or update the DPD coefficients based on the selected second memory terms, a set of basis functions and the input signal. The instruction codes may also cause the second subset of processing units to update at least one of the one or more LUTs based on the calculated coefficients and the set of basis functions. In other examples, for DPD adaptation using a direct learning architecture, the control block may further configure, based on the first model, a second subset of the processing units to execute instruction codes to calculate or update the DPD coefficients based on the selected first memory terms, a set of basis functions, and the difference between the input signal and the feedback signal and update at least one of the one or more LUTs based on the calculated coefficients and the set of basis functions.

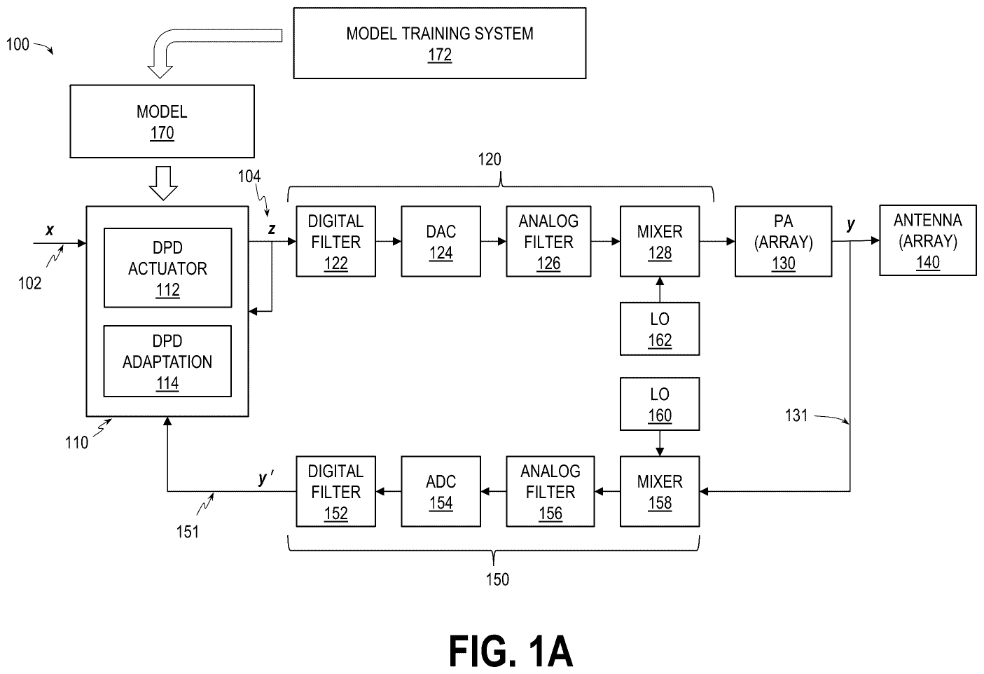

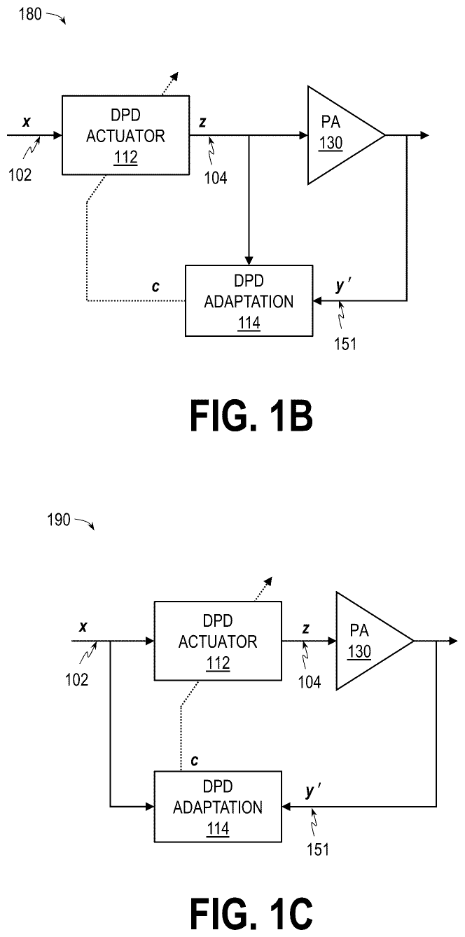

FIG. 1A provides a schematic block diagram of an example RF transceiver 100 in which a DPD as described herein may be implemented, according to some examples of the present disclosure. As shown in FIG. 1A, the RF transceiver 100 may include a DPD circuit 110, a transmitter circuit 120, a PA 130, an antenna array 140, and a receiver circuit 150.

The DPD circuit 110 is configured to receive an input signal 102, represented by x, which may be a sequence of digital samples and which may be a vector. In general, as used herein, each of the lower case, bold italics single-letter labels used in the present figures (e.g., labels x, z, y, and y′, shown in FIG. 1A), refers to a vector. In some examples, the input signal 102 x may include one or more active channels in the frequency domain, but, for simplicity, an input signal with only one channel (i.e., a single frequency range of in-band frequencies) is described. In some examples, the input signal x may be a baseband digital signal. The DPD circuit 110 is configured to generate an output signal 104, which may be represented by z based on the input signal 102 x. The DPD output signal 104 z may be provided further to the transmitter circuit 120. To that end, the DPD circuit 110 may include a DPD actuator 112 and a DPD adaptation circuit 114. In some examples, the actuator 112 may be configured to generate the output signal 104 z based on the input signal 102 x and DPD coefficients c, computed by the DPD adaptation circuit 114, as described in greater detail below.

The transmitter circuit 120 may be configured to upconvert the output signal 104 z from a baseband signal to a higher frequency signal, such as an RF signal. The RF signal generated by the transmitter circuit 120 may be provided to the PA 130, which may be implemented as a PA array that includes N individual PAs. The PA 130 may be configured to amplify the RF signal generated by the transmitter circuit 120 (thus, the PA 130 may be driven by a drive signal that is based on the output of the DPD circuit 110) and output an amplified RF signal 131, which may be represented by y (e.g., a vector).

In some examples, the RF transceiver 100 may be a wireless RF transceiver, in which case it may also include an antenna array 140. In context of wireless RF systems, antenna is a device that serves as an interface between radio waves propagating wirelessly through space and electric currents moving in metal conductors used in a transmitter, a receiver, or a transceiver. During transmission, a transmitter circuit of an RF transceiver may supply an electric signal, which signal is amplified by a PA, and an amplified version of the signal is provided to antenna's terminals. The antenna may then radiate the energy from the signal output by the PA as radio waves.

An antenna with a single antenna element will typically broadcast a radiation pattern that radiates equally in all directions in a spherical wavefront. Phased antenna arrays generally refer to a collection of antenna elements that are used to focus electromagnetic energy in a particular direction, thereby creating a main beam, a process commonly referred to as “beamforming.” Phased antenna arrays offer numerous advantages over single antenna systems, such as high gain, ability to perform directional steering, and simultaneous communication. Therefore, phased antenna arrays are being used more frequently in a myriad of different applications, such as mobile/cellular wireless technology, military applications, airplane radar, automotive radar, industrial radar, and Wi-Fi technology.

In the examples where the RF transceiver 100 is a wireless RF transceiver, the amplified RF signal 131 y can be provided to the antenna array 140, which may be implemented as an antenna array that includes a plurality of antenna elements, e.g., N antenna elements. The antenna array 140 is configured to wirelessly transmit the amplified RF signal 131 y.

In examples where the RF transceiver 100 is a wireless RF transceiver of a phased antenna array system, the RF transceiver 100 may further include a beamformer arrangement, configured to vary the input signals provided to the individual PAs of the PA 130 to steer the beam generated by the antenna array 140. Such a beamformer arrangement is not specifically shown in FIG. 1A because it may be implemented in different manners, e.g., as an analog beamformer (i.e., where the input signals to be amplified by the PA 130 are modified in the analog domain, i.e., after these signals have been converted from the digital domain to the analog domain), as a digital beamformer (i.e., where the input signals to be amplified by the PA 130 are modified in the digital domain, i.e., before these signals are converted from the digital domain to the analog domain), or as a hybrid beamformer (i.e., where the input signals to be amplified by the PA 130 are modified partially in the digital domain and partially in the analog domain).

Also, in some examples, the RF transceiver 100 may be for transmitting for transmissions through a cable (e.g., a coaxial cable) of a cable television network or similar network. In some examples where the RF transceiver 100 is used for cable implementations, a cable uptilt circuit (not shown in FIG. 1A) may be positioned prior to the PA 130 to apply an “uptilt” frequency modification to the output signal 104 z The uptilt frequency modification may compensate for frequency dependent signal loss exhibited by some cables. For example, a cable may exhibit a high frequency rolloff characteristic of about 2 dB of signal amplitude reduction per 100 MHz of frequency, such as at frequencies above 50 MHz. The uptilt frequency modification may amplify higher frequency portions of the signal that are attenuated by the cable so as to reduce frequency-dependent distortions at the signal destination.

The amplified RF signal 131 y from the PA 130 may be an upconverted and amplified version of the output of the transmitter circuit 120, e.g., an upconverted, amplified, and beamformed version of the input signal 102 x. However, as discussed above, the amplified RF signals 131 y can have distortions outside of the main signal components. Such distortions can result from nonlinearities in the response of the PA 130. The RF transceiver 100 may further include a feedback path (or observation path) that allows the RF transceiver to analyze the amplified RF signal 131 y from the PA 130 (in the transmission path). In some examples, the feedback path may be realized as shown in FIG. 1A, where a feedback signal 151 y′ may be provided from the PA 130 to the receiver circuit 150. However, in other examples, the feedback signal may be a signal from a probe antenna element configured to sense wireless RF signals transmitted by the antenna array 140 (not specifically shown in FIG. 1A).

Thus, in various examples, at least a portion of the output of the PA 130 or the output of the antenna array 140 may be provided, as a feedback signal 151, to the receiver circuit 150. The output of the receiver circuit 150 is coupled to the DPD circuit 110, in particular, to the DPD adaptation circuit 114. In this manner, an output signal 151 (y′) of the receiver circuit 150, which is a signal based on the feedback signal 151, which, in turn, is indicative of the output signal 131 (y) from the PA 130, may be provided to the DPD adaptation circuit 114 by way of the receiver circuit 150. The DPD adaptation circuit 114 may process the received signals and update DPD coefficients c applied by the DPD actuator 112 to the input signal 102 x to generate the actuator output signal 104 z A signal based on the actuator output signal 104 z is provided as an input to the PA 130, meaning that the DPD actuator output signal 104 z may be used to control the operation of the PA 130.

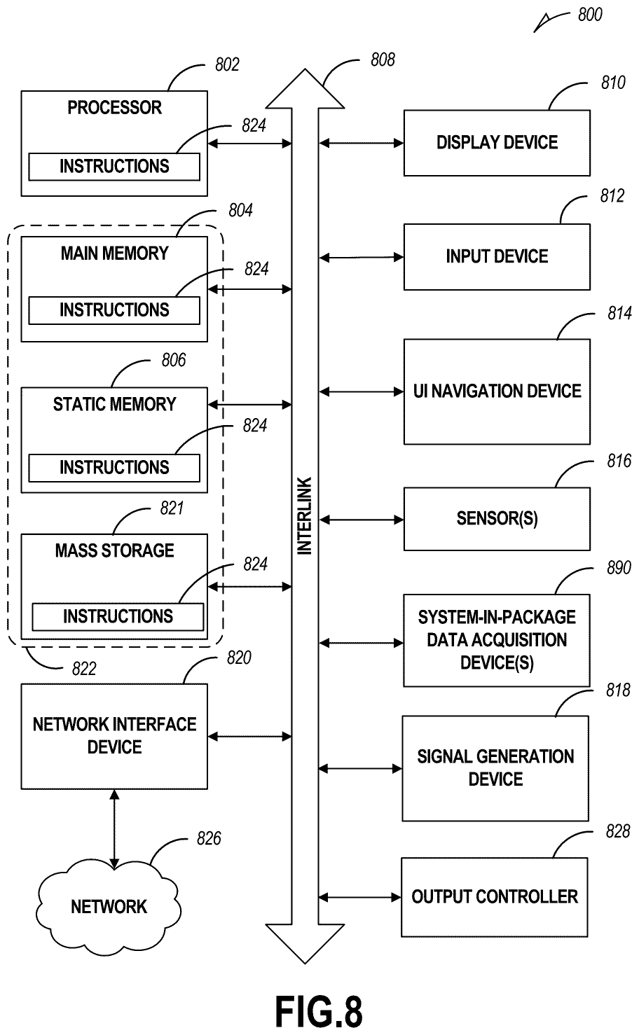

According to examples of the present disclosure, the DPD circuit 110 including the DPD actuator 112 and/or the DPD adaptation circuit 114 may be configured based on a model 170, which may be a GMP model. The model 170 may be generated offline by a model training system 172 (e.g., a computer-implemented system such as the machine 800 shown in FIG. 8). Further, the DPD actuator 112 and/or the DPD adaptation circuit 114 may be configured to implement DPD using an indirect architecture as shown in FIG. 1B or using a direct architecture as shown in FIG. 1C.

As further shown in FIG. 1A, in some examples, the transmitter circuit 120 may include a digital filter 122, a digital-to-analog converter (DAC) 124, an analog filter 126, and a mixer 128. In such a transmitter, the pre-distorted output signal 104 z may be filtered in the digital domain by the digital filter 122 to generate a filtered pre-distorted input, a digital signal. The output of the digital filter 122 may then be converted to an analog signal by the DAC 124. The analog signal generated by the DAC 124 may then be filtered by the analog filter 126. The output of the analog filter 126 may then be upconverted to RF by the mixer 128, which may receive a signal from a local oscillator (LO) 162 to translate the filtered analog signal from the analog filter 126 from baseband to RF. Other methods of implementing the transmitter circuit 120 may also be used. For example, in another implementation (not illustrated in the present drawings) the output of the digital filter 122 can be directly converted to an RF signal by the DAC 124 (e.g., in a direct RF architecture). In such an implementation, the RF signal provided by the DA C 124 can then be filtered by the analog filter 126. Since the DAC 124 would directly synthesize the RF signal in this implementation, the mixer 128 and the local oscillator 162 illustrated in FIG. 1A can be omitted from the transmitter circuit 120 in such examples.

As further shown in FIG. 1A, in some examples, the receiver circuit 150 may include a digital filter 152, an analog-to-digital converter (ADC) 154, an analog filter 156, and a mixer 158. In such a receiver, the feedback signal 151 may be down-converted to the baseband by the mixer 158, which may receive a signal from a local oscillator (LO) 160 (which may be the same or different from the local oscillator 162) to translate the feedback signal 151 from the RF to the baseband. The output of the mixer 158 may then be filtered by the analog filter 156. The output of the analog filter 156 may then be converted to a digital signal by the ADC 154. The digital signal generated by the ADC 154 may then be filtered in the digital domain by the digital filter 152 to generate a filtered downconverted feedback signal 151 y′, which may be a sequence of digital values indicative of the output y of the PA 130, and which may also be modeled as a vector. The feedback signal 151 y′ may be provided to the DPD circuit 110. Other methods of implementing the receiver circuit 150 are also possible and within the scope of the present disclosure. For instance, in another implementation (not illustrated in the present drawings) the RF feedback signal 151 y′ can be directly converted to a baseband signal by the ADC 154 (e.g., in a direct RF architecture). In such an implementation, the downconverted signal provided by the ADC 154 can then be filtered by the digital filter 152. Since the ADC 154 would directly synthesize the baseband signal in this implementation, the mixer 158 and the local oscillator 160 illustrated in FIG. 1A can be omitted from the receiver circuit 150 in such examples.

Further variations are possible to the RF transceiver 100 described above. For example, while upconversion and downconversion is described with respect to the baseband frequency, in other examples of the RF transceiver 100, an intermediate frequency (IF) may be used instead. IF may be used in superheterodyne radio receivers, in which a received RF signal is shifted to an IF, before the final detection of the information in the received signal is done. Conversion to an IF may be useful for several reasons. For example, when several stages of filters are used, they can all be set to a fixed frequency, which makes them easier to build and to tune. In some examples, the mixers of RF transmitter circuit 120 or the receiver circuit 150 may include several such stages of IF conversion. In another example, although a single path mixer is shown in each of the transmit (TX) path (i.e., the signal path for the signal to be processed by the transmitter circuit 120) and the receive (RX) path (i.e., the signal path for the signal to be processed by the receiver circuit 150) of the RF transceiver 100, in some examples, the TX path mixer 128 and the RX path mixer 158 may be implemented as a quadrature upconverter and downconverter, respectively, in which case each of them would include a first mixer and a second mixer. For example, for the RX path mixer 158, the first RX path mixer may be configured for performing downconversion to generate an in-phase (I) downconverted RX signal by mixing the feedback signal 151 and an in-phase component of the local oscillator signal provided by the local oscillator 160. The second RX path mixer may be configured for performing downconversion to generate a quadrature (Q) downconverted RX signal by mixing the feedback signal 151 and a quadrature component of the local oscillator signal provided by the local oscillator 160 (the quadrature component is a component that is offset, in phase, from the in-phase component of the local oscillator signal by 90 degrees). The output of the first RX path mixer may be provided to a I-signal path, and the output of the second RX path mixer may be provided to a Q-signal path, which may be substantially 90 degrees out of phase with the I-signal path. In general, the transmitter circuit 120 and the receiver circuit 150 may utilize a zero-IF architecture, a direct conversion RF architecture, a complex-IF architecture, a high (real) IF architecture, or any suitable RF transmitter and/or receiver architecture.

In general, the RF transceiver 100 may be any device/apparatus or system configured to support transmission and reception of signals in the form of electromagnetic waves in the RF range of approximately 3 kHz to 300 GHz. In some examples, the RF transceiver 100 may be used for wireless communications, e.g., in a base station (BS) or a user equipment (UE) device of any suitable cellular wireless communications technology, such as Global System for Mobile Communication (GSM), Code Division Multiple Access (CDMA), or LTE. In a further example, the RF transceiver 100 may be used as, or in, e.g., a BS or a UE device of a millimeter-wave wireless technology such as 5G wireless (i.e., high frequency/short wavelength spectrum, e.g., with frequencies in the range between about 20 and 60 GHz, corresponding to wavelengths in the range between about 5 and 15 millimeters). In yet another example, the RF transceiver 100 may be used for wireless communications using Wi-Fi technology (e.g., a frequency band of 2.4 GHz, corresponding to a wavelength of about 12 cm, or a frequency band of 5.8 GHz, spectrum, corresponding to a wavelength of about 5 cm), e.g., in a Wi-Fi-enabled device such as a desktop, a laptop, a video game console, a smart phone, a tablet, a smart TV, a digital audio player, a car, a printer, etc. In some implementations, a Wi-Fi-enabled device may, e.g., be a node in a smart system configured to communicate data with other nodes, e.g., a smart sensor. Still in another example, the RF transceiver 100 may be used for wireless communications using Bluetooth technology (e.g., a frequency band from about 2.4 to about 2.485 GHz, corresponding to a wavelength of about 12 cm). In other examples, the RF transceiver 100 may be used for transmitting and/or receiving wireless RF signals for purposes other than communication, e.g., in an automotive radar system, or in medical applications such as magneto-resonance imaging (MRI). In still other examples, the RF transceiver 100 may be used for cable communications, e.g., in cable television networks.

FIG. 1B provides a schematic block diagram of an example indirect architecture-based DPD 180, according to some examples of the present disclosure. In some examples, the DPD circuit 110 of FIG. 1A may be implemented as shown in FIG. 1B, and the model training system 172 may train the model 170 to configure the DPD circuit 110 for indirect adaptation. For simplicity, the transmitter circuit 120 and the receiver circuit 150 are not shown in FIG. 1B and only elements related to performing DPD are shown.

For indirect adaption, the DPD adaptation circuit 114 may use the observed received signal (e.g., the feedback signal 151 y′) as a reference to predict PA input samples corresponding to the reference. The function used for predicting the input samples is known as an inverse PA model (to linearize the PA 130). Once the prediction of input samples corresponding to the observed data is good (e.g., when the error between the predicted input samples and the pre-distorted output signal 104 z satisfies certain criteria), the estimated inverse PA model is used to pre-distort transmit data (e.g., the input signal 102 x) to the PA 130. That is, the DPD adaptation circuit 114 may compute the inverse PA model that is used by the DPD actuator 112 to pre-distort the input signal 102 x. To that end, the DPD adaptation circuit 114 may observe or capture N samples of PA input samples (from the pre-distorted output signal 104 z) and N samples of PA output samples (from the feedback signal 151 y′), compute a set of M coefficients, which may be represented by c, corresponding to the inverse PA model, and update the DPD actuator 112 with the coefficients c as shown by the dotted arrow. In some examples, the DPD adaptation circuit 114 may solve for the set of coefficients c using a least square approximation.

FIG. 1C provides a schematic block diagram of an example direct architecture-based DPD 190 in which a model-based configuration may be implemented, according to some examples of the present disclosure. In some examples, the DPD circuit 110 of FIG. 1A may be implemented as shown in FIG. 1C, and the model training system 172 may train the model 170 to configure the DPD circuit 110 for direct learning. For simplicity, the transmitter circuit 120 and the receiver circuit 150 are not shown in FIG. 1C and only elements related to performing DPD are shown.

For a direct model, the DPD adaptation circuit 114 may use the input signal 102 x as a reference to minimize the error between the observed received data (e.g., the feedback signal 151 y′) and the transmit data (e.g., the input signal 102 x). In some examples, the DPD adaptation circuit 114 may use an iterative technique to compute a set of M coefficients, which may be represented by c, used by the DPD actuator 112 to pre-distort the input signal 102 x. For instance, the DPD adaptation circuit 114 may compute current coefficients based on previously computed coefficients (in a previous iteration) and currently estimated coefficients. The DPD adaptation circuit 114 may compute the coefficients to minimize an error indicative of a difference between the input signal 102 x and the feedback signal 151 y′. The DPD adaptation circuit 114 may update the DPD actuator 112 with the coefficients c as shown by the dotted arrow.

In some examples, the DPD actuator 112 in the indirect architecture-based DPD 180 of FIG. 1B or the direct architecture-based DPD 190 of FIG. 1C may implement DPD actuation using a Volterra series or a GMP model (which is a subset of the Volterra series) as shown below:

$$z [ n ] = {\sum }_{ij} {\sum }_{k} {c}_{ijk} {f}_{k} ( ‖ x [ n - i ] ‖ ) x [ n - j ] \qquad ( 1 )$$

where z[n] represents an nth sample of the pre-distorted output signal 104 z, fₖ(.) represents a k^{th} function of a DPD model (e.g., including a set of M basis functions), cᵢⱼₖ represents the set of DPD coefficients (e.g., for combining the set of M basis functions), x[n−i] and x[n−j] represent samples of the input signal 102 delayed by i and j number of samples, respectively, and ∥x[n−i]∥ represents the envelope or amplitude of the sample x[n−i]. In some instances, the values for sample delays i and j may be dependent on the PA 130's nonlinear characteristic(s) of interest for the pre-distortion, and), x[n−i] and x[n−j] may be referred to as i,j cross-memory terms. While equation (1) illustrates that the GMP model is applied to the envelope or amplitude of the input signal 102 x, examples are not limited thereto. In general, the DPD actuator 112 may apply DPD actuation to the input signal 102 x directly or after pre-processing the input signal 102 x according to a pre-processing function represented by P( ) which may be an amplitude function, an amplitude-squared, or any suitable function.

In some examples, the DPD actuator 112 may implement equation (1) using one or more lookup tables (LUTs). For example, the terms

$${\sum }_{k} {c}_{ijk} {f}_{k} ( ‖ x [ n - i ] ‖ )$$

may be stored in a LUT, where the LUT for the i,j cross-memory terms may be represented by:

$${L}_{i , j} ( ‖ x [ n - i ] ‖ ) = {\sum }_{k} {c}_{ijk} {f}_{k} ( ‖ x [ n - i ] ‖ ) \qquad ( 2 )$$

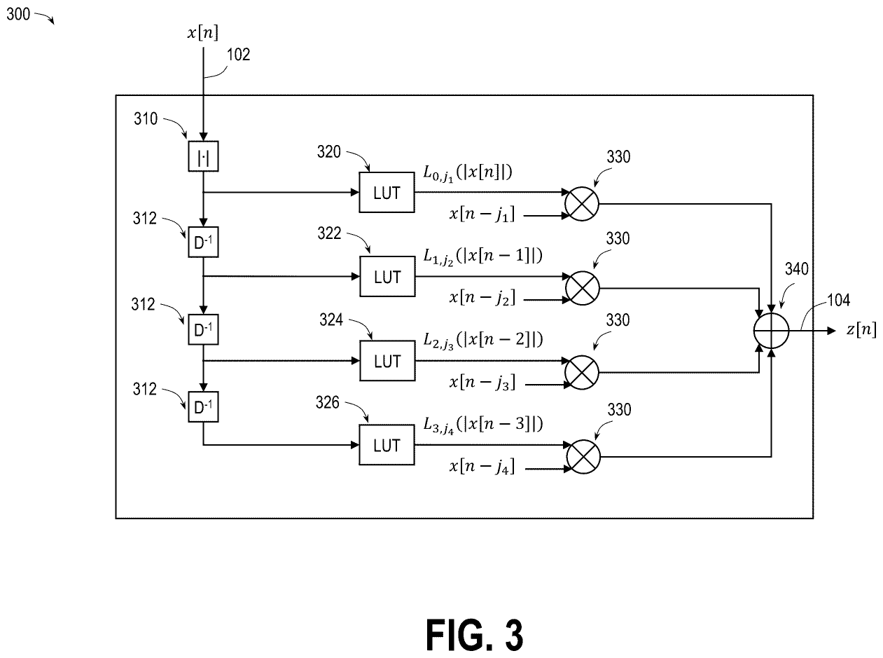

Accordingly, the operations of the DPD actuator 112 may include selecting first memory terms (e.g., x[n−i] and x[n−j]) from an input signal 102 x and generating a pre-distorted output signal 104 z based on the LUT and the selected first memory terms as will be discussed more fully below with reference to FIGS. 3-5. For DPD adaptation using the direct architecture shown in FIG. 1C, the operations of the DPD adaptation circuit 114 may include calculating DPD coefficients (e.g., a set of coefficients cₖ) based on the selected first memory terms and the set of basis functions fₖ and updating the one or more LUTs based on the calculated coefficients. On the other hand, for DPD adaptation using the indirect learning architecture shown in FIG. 1B, the operations of the DPD adaptation circuit 114 may include selecting second memory terms (e.g., y′[n−i] and y′[n−j] from a feedback signal 151 y′, calculating DPD coefficients (e.g., a set of coefficients cₖ) based on the selected second memory terms and the set of basis functions fₖ and updating the one or more LUTs based on the calculated coefficients. As such, the DPD circuit 110 may include various circuits such as memory to store LUTs for various cross-memory terms, multiplexers for memory term selections, multipliers, adders, and various other digital circuits and/or processor(s) for executing instructions to perform DPD operations (e.g., actuation and adaptation).

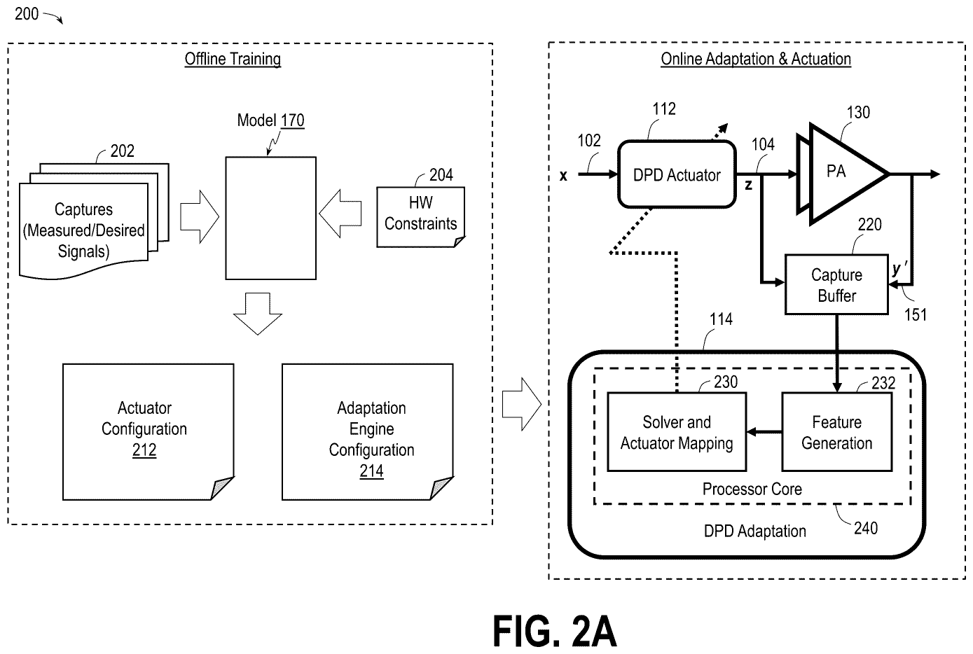

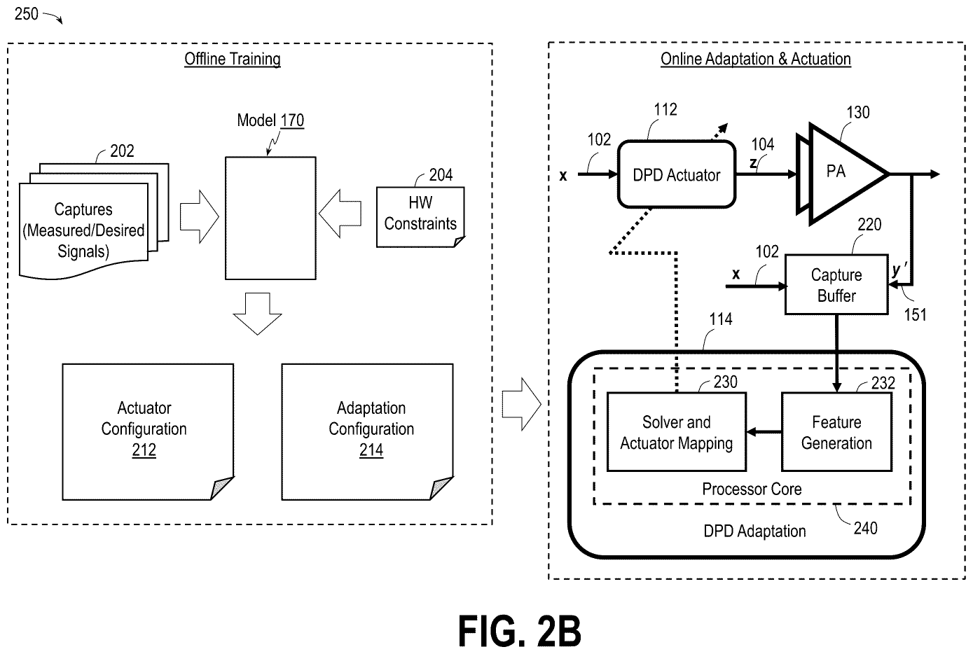

According to examples of the present disclosure, the model training system 172 may train the model 170 to configure the DPD actuator 112 and/or the DPD adaptation circuit 114 to perform these DPD actuation and adaptation (indirect and/or direct learning) operations. Mechanisms for training the model 170 (e.g., during offline) and configuring a DPD hardware for actuation and adaptation (e.g., during online) according to the trained model 170 will be discussed more fully below with reference to FIGS. 2A-2B, and 3-7. For simplicity, FIGS. 2A-2B and 3-7 are discussed using the same signal representations as in FIGS. 1A-1C. For example, the symbol x may refer to an input signal to a DPD actuator circuit that linearizes a PA, the symbol z may refer to an output signal (pre-distorted signal) provided by a DPD, the symbol y may refer to an output of the PA, the symbol y′ may refer to an observed received signal indicative of an output of the PA, and the symbol c may refer to DPD coefficients for combining basis functions associated with features or nonlinearities of a PA. Further, the input signal 102 x and the pre-distorted output signal 104 z can be referred to as transmission data (TX), and the feedback signal 151 y′ can be referred to as observation data (ORx).

An aspect of the present disclosure includes LUT-based DPD actuators designed for GMP models (e.g., as shown in equation (1)). In some examples, the LUT-based DPD actuator may include multiplexers that choose one signal among a pluralities of input signals (e.g., for memory selections). In some examples, the LUT-based DPD actuator may include LUTs (e.g., as shown in equation (2)) that are configured to take one signal as input and generate outputs according to the input as will be discussed more fully below with reference to FIGS. 3-7.

FIGS. 2A and 2B are discussed in relation to FIG. 1A-1C to illustrate model architecture search mechanisms applied to DPD hardware. FIG. 2A provides an illustration of a scheme 200 for offline training and online adaptation and actuation for an indirect learning architecture-based DPD (e.g., the DPD 180), according to some examples of the present disclosure. The scheme 200 includes an offline training shown on the left side of FIG. 2A and an online adaptation and actuation DPD on the right side of FIG. 2A.

In some examples, an offline training system (e.g., the model training system 172) may include a transceiver system, a processor and memory system. The transceiver system may be substantially similar to a target system in which the DPD actuation and adaptation are to be implemented. For instance, the transceiver system may include a PA (e.g., the PA 130), a transmission path (in which an input signal 102 x may be pre-distorted by a DPD actuator 112 and transmitted via the PA 130), and an observation path (in which a feedback signal 151 y′ indicative of an output of the PA 130 may be received) substantially similar to the RF transceiver 100 of FIG. 1A.

The processor and memory system (e.g., a computer-implemented system such as the machine 800 shown in FIG. 8) may be configured to perform a plurality of captures of the transceiver system's transmission and observation data shown as captures 202 including measured and/or signals. In particular, for indirect DPD, the captures 202 may include the pre-distorted output signal 104 z and the feedback signal 151 y′ captured from the hardware component and/or desired pre-distorted signals and/or feedback signals for corresponding input signals. M ore specifically, the captures may be performed at certain intervals (e.g., at every 0.5 sec, 1 sec, 2 secs or more), each capture may include L samples of the input signal 102 x, M consecutive samples of the pre-distorted output signal 104 z and/or N samples of the feedback signal 151 y′, where L, M, N may be the same or different.

The processor and memory system may generate a model 170 with a 1-to-1 mapping to the hardware blocks or circuits at the actuator 112 and the DPD adaptation circuit 114. The processor and memory system may generate the model 170 further based on hardware constraints 204 (e.g., target resource utilization or power consumption) associated with the actuator 112 and the DPD adaptation circuit 114. The processor and memory system may further perform an optimization algorithm that takes the transmission and observation captures 202 and optimizes actuator model parameters and adaptation model parameters for the model 170.

After completing the optimization, the processor and memory system may convert the optimized model 170 (with optimized parameters) to configurations, for example, an actuator configuration 212 and an adaptation engine configuration 214, that can be loaded onto a firmware for configuring a corresponding hardware for online operations. In some examples, the model 170 may be trained for a certain type of PA 130 having certain nonlinear characteristics, and thus the actuator configuration 212 and the adaptation engine configuration 214 may include parameters for configuring a DPD actuator and a DPD adaptation engine, respectively, to pre-compensate for those nonlinear characteristics. In some examples, the actuator configuration 212 may indicate information for configuring LUTs for DPD actuation and the adaptation engine configuration 214 may indicate information associated with basis functions to be used for adapting coefficients used by the DPD actuator.

In some examples, an on-chip DPD sub-system for actuation and adaptation may include a DPD actuator 112, a PA 130, a transmission path (in which an input signal 102 x may be pre-distorted by a DPD actuator 112 and transmitted via the PA 130), an observation path (in which a feedback signal 151 y′ indicative of an output of the PA 130 may be received), a capture buffer 220, and a processor and memory system (e.g., including a processor core 240) as shown on the right side of FIG. 2A. The DPD actuator 112 may include LUTs (e.g., equation (2)) and memory-term programmable delays and multiplexers. The processor and memory system may be configured to configure DPD actuator 112's memory-term programmable delays and multiplexers according to offline trained parameters (e.g., indicated by the actuator configuration 212). The processor and memory system may perform memory term selection and basis function generation (shown by the feature generation 232 at the DPD adaptation circuit 114) according to offline trained parameters (e.g., indicated by the adaptation engine configuration 214) and the data in the capture buffer 220. In particular, for indirect learning DPD, the processor and memory system may capture the pre-distorted output signal 104 z output by the DPD actuator 112 and the feedback signal 151 y′ at the capture buffer 220. The processor and memory system may further use selected memory terms and generated basis functions to solve for a set of linear combination coefficients (shown by the solver and actuator mapping 230 at the DPD adaptation circuit 114). In some examples, the solver and actuator mapping 230 may utilize least square approximation techniques to solve to the set of linear combination coefficients. The processor and memory system may further generate LUT entries from the solved coefficients and the basis functions according to offline trained parameters (e.g., indicated by the adaptation engine configuration 214) and map to corresponding memory term LUTs. Further, in some examples, the DPD actuator 112 may be implemented by digital hardware blocks or circuits, and the DPD adaptation circuit 114 may be implemented by the processor core 240 executing instruction codes (e.g., a firmware) that performs the feature generation 232 and the solver and actuator mapping 230.

FIG. 2B provides an illustration of a scheme 250 for offline training and online DPD adaptation and actuation for a direct architecture-based DPD (e.g., the DPD 190), according to some examples of the present disclosure. The scheme 250 of FIG. 2B is similar to the scheme 200 of FIG. 2A in many respects; for brevity, a discussion of these elements is not repeated, and these elements may take the form of any of the examples disclosed herein.

As mentioned above with reference to FIG. 1C, for a direct learning DPD, the DPD adaptation circuit 114 may compute the coefficients to minimize an error indicative of a difference between the input signal 102 x and the feedback signal 151 y′. Accordingly, in the scheme 250, for offline training on the left side of FIG. 2B, the offline processor and memory system (e.g., a computer-implemented system such as the machine 800 shown in FIG. 8) may perform a plurality of captures of the input signal 102 x and the feedback signal 151 y′ from the hardware component. That is, the captures 202 may include input signal 102 x and the feedback signal 151 y′ collected from the hardware component and/or desired feedback signals for corresponding input signals. Further, as shown in the right side of FIG. 2B, the on-chip DPD sub-system for actuation and adaptation may capture the input signal 102 x and the feedback signal 151 y′ at the capture buffer 220. The feature generation 232 may be based on the input signal 102 x and the feedback signal 151 y′. Further, in some examples, the solver and actuator mapping 230 may solve for set of linear combination coefficients used by the DPD actuator 112 using an iterative solution approach.

### Example Offline Model Training for a Hardware Component Using Model Architecture Search Techniques

Accordingly, in some examples, a computer-implemented system (e.g., the model training system 172 of FIG. 1A) may implement an offline training method for performing a model architecture search to optimize a hardware configuration for a hardware component to perform a certain data transformation (e.g., DPD actuation and/or adaptation) as shown in the offline training of FIGS. 2A and 2B. The data transformation can include linear and/or nonlinear operations. The hardware component (e.g., the on-chip DPD subsystem shown on the right side of FIG. 2A) may include a pool of processing units that can perform at least arithmetic operations and/or signal selection operations (e.g., multiplexing and/or de-multiplexing). The model architecture search may be performed over a search space including the pool of processing units and associated capabilities, a desired hardware resource constraint (e.g., HW constraints 204), and/or hardware operations associated with the data transformation. The model architecture search may also be performed to achieve a certain desired performance metric associated with the data transformation, for example, to minimize an error metric associated with the data transformation.

To perform the model architecture search, the computer-implemented system may receive information associated with the pool of processing units. The received information may include hardware resource constraints (e.g., the HW constraints 204), hardware operations (e.g., signal selections, multiplication, addition, address generation for table lookup, etc.), and/or hardware capabilities (e.g., speed, delays, etc.) associated with the pool of processing units. The computer-implemented system may further receive a data set (e.g., the captures 202) associated with the data transformation operation. The data set may be collected on the hardware component and may include input data, output data, control data, etc. That is, the data set may include signals measured from the hardware component and/or desired signals. In some examples, the data set may include captures of the input signal 102 x, the pre-distorted output signal 104 z and/or the feedback signal 151 y′, for example, depending on whether a direct DPD architecture or an indirect DPD architecture is used. The computer-implemented system may train a model (e.g., the model 170) associated with the data transformation using the received hardware information and the received data set. The training may include updating at least one parameter of the parametrized model associated with configuring at least a subset of the processing units in the pool (to perform the data transformation). The computer-implemented system may output one or more configurations (e.g., the actuator configuration 212 and the adaptation engine configuration 214) for at least the subset of the processing units in the pool.

In an example of modelling DPD actuation for offline training, the first data transformation in the sequence may include selecting, based on the first parameter, memory terms from the input signal (e.g., the input signal 102 x). The second data transformation in the sequence may include generating, based on the second parameter, feature parameters associated with a nonlinear characteristic of the PA 130 using a set of basis functions (e.g., ƒₖ(.)) and the selected memory terms. The sequence associated with the data transformation operation may further include a third data transformation including generating a pre-distorted signal (e.g., the pre-distorted output signal 104 z) based on the feature parameter.

In an example of modeling DPD adaptation for offline training, the first data transformation in the sequence may include selecting, based on the first parameter, memory terms from a feedback signal (e.g., the feedback signal 151 y′) indicative of an output of the nonlinear electronic component or the input signal. The second data transformation in the sequence may include generating, based on the second parameter, features associated with a nonlinear characteristic of the PA 130 using a set of basis functions (e.g., ƒₖ), DPD coefficients (e.g., cₖ) and the selected memory terms. The sequence associated with the data transformation operation may further include a third data transformation including updating coefficients based on the features and a second signal. The second signal may correspond to the pre-distorted output signal 104 z when using an indirect learning DPD (e.g., as shown in FIG. 1B). Alternatively, the second signal may correspond to a difference between input signal 102 x and the feedback signal 151 y′ when using a direct learning DPD (e.g., as shown in FIG. 1C).

### Example Online Hardware Operations Based on a Model Trained Using Model Architecture Search Techniques

In some examples, an apparatus may be configured based on a model (e.g., the model 170) trained as discussed herein for online operations. For example, the apparatus may include an input node to receive an input signal and a pool of processing units to perform one or more arithmetic operations (e.g., multiplications, additions, etc.) and/or one or more signal selection operations (e.g., multiplexing and/or de-multiplexing, address generations, etc.). Each of the processing units in the pool may be associated with at least one model (e.g., a NAS model) corresponding to a data transformation (e.g., including linear operations, nonlinear operations, DPD operations, etc.). The apparatus may further include a control block (e.g., control registers) to configure and/or select, based on a first model (e.g., the model 170), at least a first subset of the processing units to process the input signal to generate a first signal. In some examples, the first model may be trained offline based on a mapping between each of the processing units in the pool to a different one of a plurality of differentiable building blocks and at least one of an input data set or an output data set collected on a hardware component or a hardware constraint (e.g., a target resource utilization and/or power consumption). For example, the training may be based on a NAS over the plurality of differentiable building blocks as discussed herein.

In some examples, the data transformation may include a sequence of data transformations. For example, the data transformations may include a first data transformation followed by a second data transformation, where the first data transformation transforms the input signal into the first signal and the second data transformation transforms the first signal into a second signal. In some examples, the sequence of data transformations may be performed by a combination of digital hardware block(s) (e.g., digital circuits) and processor(s) executing instruction codes (e.g., software or firmware). For example, the first subset of the processing units may include digital hardware blocks (e.g., digital circuits) to perform the first transformation, and the control block may further configure a second subset of the processing units in the pool to execute instruction codes to perform the second transformation.

In some examples, the apparatus may be a DPD apparatus (e.g., DPD circuit 110) for pre-distorting an input signal to a nonlinear electronic component. For example, the received input signal may correspond to the input signal 102 x, the nonlinear electronic component may correspond to the PA 130, and the first signal may correspond to the pre-distorted output signal 104 z The apparatus may further include a memory to store, based on the first model, one or more lookup tables (LUTs) associated with one or more nonlinear characteristics of the nonlinear electronic component. The apparatus may further include a DPD block including the first subset of the processing units to select first memory terms (e.g., the), x[n−i] and x[n−j] terms shown in equation (1)) from the input signal based on the first model. The first subset of the processing units may further generate the pre-distorted signal based on the one or more LUTs (e.g., L_{i,j} shown in equation (2)) and the selected first memory terms (e.g., for DPD actuation). In some examples, the first subset of the processing units may further select, based on the first model, second memory terms (e.g., y′[n−i] and y′[n−j]) from a feedback signal (e.g., feedback signal 151 y′) associated with an output of the nonlinear electronic component. The control block may further configure, based on the first model, a second subset of the processing units to execute instruction codes to calculate, based on the selected second memory terms and a set of basis functions, DPD coefficients (e.g., the set of coefficients cₖ) and update, based on the calculated coefficients and the set of basis functions, at least one of the one or more LUTs (e.g., for DPD adaptation).

### Example LUT-Based DPD Actuator Implementations

As discussed above, in some examples, the LUT-based DPD actuator may include multiplexers which choose one signal among a pluralities of input signals. In some examples, the LUT-based DPD actuator contains LUTs that are configured to take one signal as input and generate outputs according to the input. FIGS. 3-5 illustrate various implementations for LUT-based DPD actuators.

FIG. 3 provides an illustration of an example implementation for a LUT-based DPD actuator circuit 300, according to some examples of the present disclosure. For instance, the DPD actuator 112 of FIGS. 1A-1C, 2A-2B may be implemented as shown in FIG. 3. As shown in FIG. 3, the LUT-based DPD actuator circuit 300 may include a complex-to-magnitude conversion circuit 310, tapped delay lines 312, a plurality of LUTs 320, 322, 324, 326, complex multipliers 330, and an adder 340. For simplicity, FIG. 3 illustrates three tapped delay lines 312. However, the LUT-based DPD actuator circuit 300 may be scaled to include any suitable number of tapped delay lines 312 (e.g., 1, 2, 3, 4, 5, 10, 100, 200, 500, 1000 or more).

The LUT-based DPD actuator circuit 300 may receive an input signal 102 x, for example, including a block of samples x[n], where N may vary from 0 to (N−1) and may be represented as x₀, x₁, . . . , x_{N-1}. In some instances, the input signal 102 x may be a digital baseband complex in-phase, quadrature-phase (IQ) signal. The complex-to-magnitude conversion circuit 310 may compute an absolute value or magnitude for each complex sample x[n]. The tapped delay line 312 may generate a delayed version of the magnitudes of the input signal 102 x, for example, |x₀|, |x₁|, . . . , |x_{N-1}|. The LUT 320 (e.g., the LUT for L_{0,j1}) may take the magnitude of the signal |x[n]| as inputs and generate outputs L_{0,j}_{₁}(|x[n]|). In a similar way, the LUT 322 (e.g., the LUT for L_{1,j2}) may take the magnitude of the signal |x[n−1]| as inputs and generate outputs L_{1,j}_{₂}(|x[n−j2]|), the LUT 324 (e.g., the LUT for L_{2,j}_{₃}) may take the magnitude of the signal |x[n−2]| as inputs and generate outputs L_{2,j}_{₃}(|x[n=j3]|), and the LUT 326 (e.g., the LUT for L_{3,j}_{₄}) may take the magnitude of the signal |x[n−3]| as inputs and generate outputs L_{3,j}_{₄}(|x[n−j4]|). The outputs of the LUTs 320, 322, 324, 326 are then multiplied with x[n−j1], x[n−j2], x[n−j3], and x[n−j4], respectively, at the complex multipliers 330. The products from the outputs of the complex multipliers 330 are summed at the adder 340 to provide an output, z[n], for the actuator circuit 300, where the output may correspond to the pre-distorted output signal 104 z

While FIG. 3 illustrates the LUTs 320, 322, 324, 326 as separate LUTs, each corresponding to a certain i,j cross-memory terms (e.g., modeling certain nonlinear characteristic(s) of the PA 130), in general, the LUT-based DPD actuator circuit 300 may store the LUTs 320, 322, 324, 326 in any suitable forms.

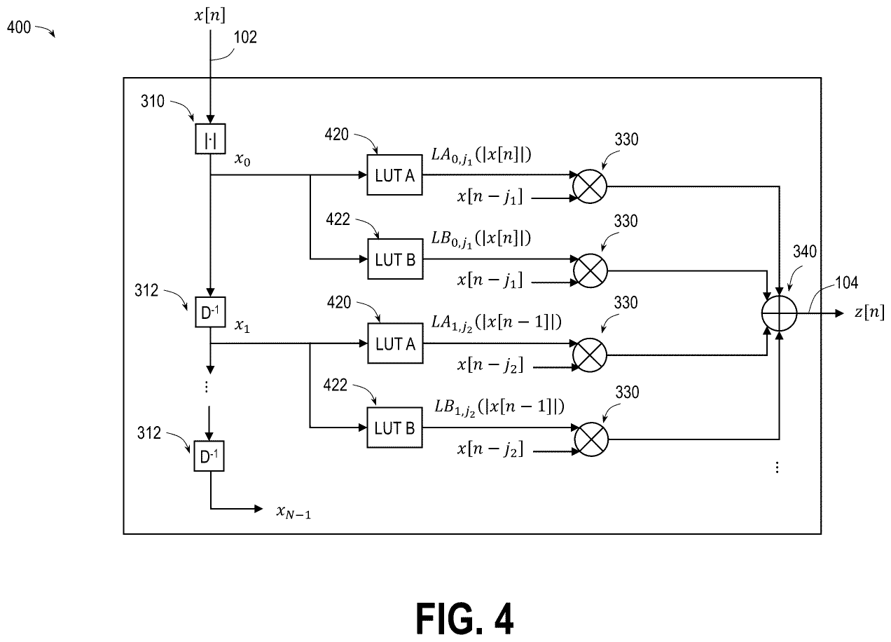

FIG. 4 provides an illustration of an example implementation for a LUT-based DPD actuator circuit 400, according to some examples of the present disclosure. For instance, the DPD actuator 112 of FIGS. 1A-1C, 2A-2B may be implemented as shown in FIG. 4. The LUT-based DPD actuator circuit 400 of FIG. 4 is similar to the LUT-based DPD actuator circuit 300 of FIG. 3 in many respects; for brevity, a discussion of these elements is not repeated, and these elements may take the form of any of the examples disclosed herein.

In FIG. 4, the LUT-based DPD actuator circuit 400 may utilize multiple LUTs to generate a pre-distorted signal sample z [n] instead of a single LUT for each pre-distorted sample z [n] as in the LUT-based DPD actuator circuit 300 of FIG. 3. For simplicity, FIG. 4 illustrates the LUT-based DPD actuator circuit 400 utilizing two LUTs, a LUT A 420 and a LUT B 422, to generate each pre-distorted sample z [n]. However, the LUT-based DPD actuator circuit 400 may be scaled to use any suitable number of LUTs (e.g., about 3, 4 or more), to generate each pre-distorted sample z [n]. Further, in order not to clutter the drawings of FIG. 4, FIG. 4 only illustrates LUT A 420 and LUT B 422 for the first two samples, x₀ and x₁, but the LUT A 420 and LUT B 422 may be included for each of the delayed sample x₂, x₃, . . . , x_{N-1}.

As shown in FIG. 4, for the sample x[n], the LUT A 420 may take the magnitude of the signal |x[n]| as inputs and generate outputs LA_{0,j}_{₁}(|x[n]|) and the LUT B 422 may take the magnitude of the signal |x[n]| as inputs and generate outputs LB_{0,j1}(|x[n]|). In a similar way, for the sample |x[n−1]| the LUT A 420 may take the magnitude of the signal |x[n−1]| as inputs and generate outputs LA_{1,j}_{₂}(|x[n−1]|) and the LUT B 422 may take the magnitude of the signal |x[n−1]| as inputs and generate outputs LB_{1,j}_{₂}(|x[n−1]|), and so on. In some examples, the LUT A 420 and the LUT B 422 may each model a different nonlinear characteristic of the PA 130. The outputs of the LUTs 420 and 422 for each sample x[n], x[n−1], . . . , x[n−N−1] are multiplied with respective memory terms x[n−j1], x[n−j2], . . . , at the complex multipliers 330. The products from the outputs of the complex multipliers 330 are summed at the adder 340 to provide an output, z [n], for the LUT-based DPD actuator circuit 400, where the output may correspond to the pre-distorted output signal 104 z

While FIG. 4 illustrates the LUTs 420 and 422 as separate LUTs, each corresponding to a certain i,j cross-memory terms, in general, the LUT-based DPD actuator circuit 400 may store the LUTs 420 and 422 in any suitable forms.

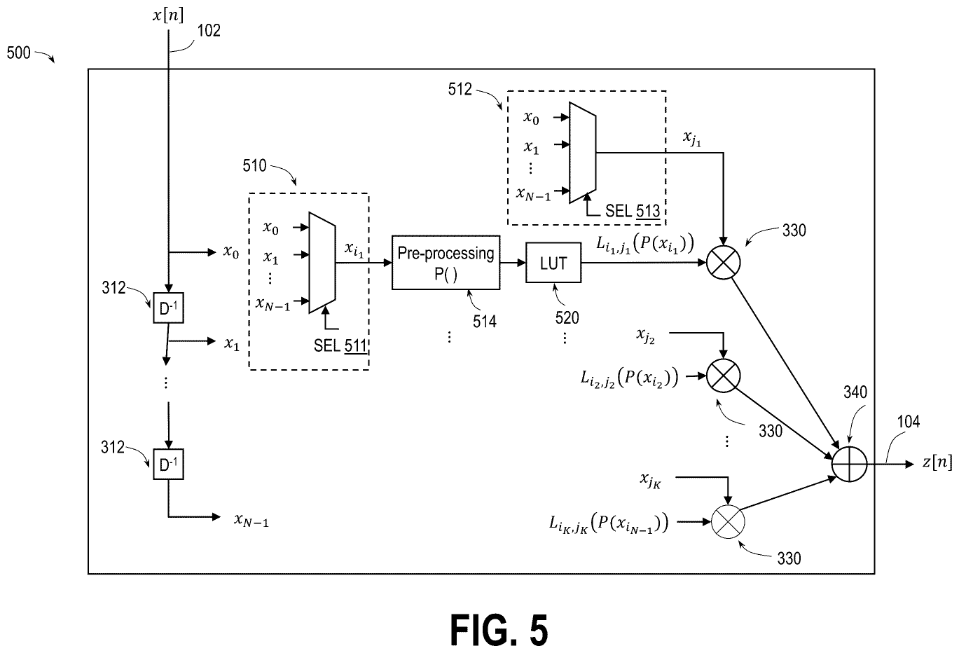

FIG. 5 provides an illustration of an example implementation for a LUT-based DPD actuator circuit 500, according to some examples of the present disclosure. For instance, the DPD actuator 112 of FIGS. 1A-1C, 2A-2B may be implemented as shown in FIG. 5. The LUT-based DPD actuator circuit 500 of FIG. 5 is similar to the LUT-based DPD actuator circuit 300 of FIG. 3 in many respects; for brevity, a discussion of these elements is not repeated, and these elements may take the form of any of the examples disclosed herein. As shown in FIG. 5, the LUT-based DPD actuator circuit 500 may include a tapped delay line 312, a plurality of signal multiplexers 510, a plurality of pre-processing circuits 514 (e.g., represented by a pre-processing function P(.)), a plurality of LUTs 520, a plurality of signal multiplexers 512, a plurality of multipliers 330, and an adder 340. In order not to clutter the drawings of FIG. 5, FIG. 5 only illustrates a signal multiplexer 510, a pre-processing circuit 514, a LUT 520, and a signal multiplexer 512 for the first sample, x₀, but a signal multiplexer 510, a pre-processing circuit 514, a LUT 520, and a signal multiplexer 512 may be arranged for each of the delayed sample x₁, x₂, . . . , x_{N-1} in a similar way as for the sample x₀.

As shown FIG. 5, the tapped delay line 312 generates delayed versions of the input signal 102 x, for example, represented as x₀, x₁, . . . , x_{N-1}. Each multiplexer 510 chooses one signal, xᵢ, among all possible inputs based on a selection signal 511. Each signal multiplexer 512 chooses one signal, xⱼ, among all possible inputs based in a selection signal 513. Each pre-processing circuit 514 pre-processes a respective chosen signal xᵢ. The pre-processing can be a complex envelope or amplitude computation, magnitude-square, a scaling function, or any suitable pre-processing function. Each LUT 520 takes the processed signal P(xᵢ) as inputs and generates outputs, L_{i,j}(P(xᵢ)). The outputs of the LUTs 520 are then multiplied with the respective signal chosen by the signal multiplexer 512 at the complex multipliers 330. The products from the outputs of the complex multipliers 330 are summed at the adder 340 to provide an output, z [n], for the actuator circuit 300, where the output may correspond to the pre-distorted output signal 104 z

The hardware implementations for LUT-based DPD actuators shown in FIGS. 3-5 may be used to drive a model architecture search for a DPD block. In some examples, selection signal 511 for the multiplexer 510, the selection signal 513 for the multiplexer 512, and the LUT 520 may be mapped to learnable parameters trained as part of the model architecture search, as will be discussed more fully below.

### Mapping Hardware Blocks to Model Elements

According to examples of the present disclosure, a computer-implemented system may create a software model of a DPD actuator hardware (e.g., the LUT-based DPD actuators shown in FIGS. 3-5) that captures relevant hardware constraints (e.g., allowed memory terms, LUTs, model size, etc.). The software model can include the adaptation step (e.g., a linear-least-squares adaptation in the case of indirect learning DPD or an iterative solution in the case of direct learning DPD) in the model to determine the set of DPD coefficients c (e.g., as shown in equation (1) above). In some examples, the nonlinear LUT basis functions (e.g., ƒₖ(.)) may be arbitrary (GMP restricts them to be polynomial). For example, a sequence of NN layers may be used. In some examples, the memory term multiplexing may be modeled using vector dot-product parameterized with weights w.

The nonlinear functions may be co-optimized along with the choice of memory terms in offline pre-training phase and may be used without adaptation (i.e., any means of changing pre-trained parameters) in post-deployment operations.

In some examples, “learnable” multiplexing layers may be used to enable optimization of the choice of memory terms. This may be done to perform “N choose M” (M<N) operation with learnable parameters.

In some examples, the parameters of the LUT basis functions and the “learnable” multiplexing layers may be trained to minimize a final least square error. For example, in some examples, this may be done using gradient descent with backpropagation.

In some examples, the generation of the software model may include replicating hardware operations in specifically designed differentiable building blocks, reproducing a sequence of hardware events as differentiable computational graph, and optimizing a hardware configuration offline with hardware capabilities and constraints.

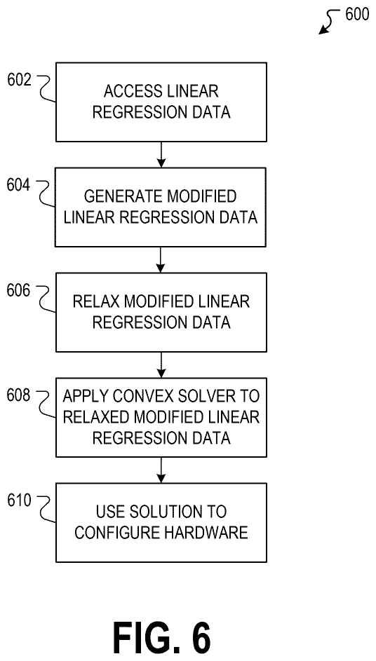

FIG. 6 is a flowchart showing one example of a process flow 600 that may be executed, in various examples, to arrange a hardware component to implement a processing task. In some examples, the processing task comprises digital pre-distortion of an input signal, for example, as described herein with respect to FIGS. 1-5. The process flow 600, in some examples, may be executed by a model training system distinct from a DPD or PA circuit such as, for example, the model training system 172. Such a model training system may generate a model comprising a solution to a linear regression, as described herein. The model may be provided to a DPD actuator, such as the DPD actuator 112, to perform digital predistortion. In other examples, the process flow 600 may be executed by a model training system that is part of a DPD or PA circuit.

At operation 602, the model training system may access linear regression data. The linear regression data may describe the processing task. For example, the linear regression data may comprise a target vector describing an output of the hardware component, a measurement vector describing measurements on which the output of the hardware component is based, and a weight vector describing weights applied to the measurement vector to generate the target vector. In examples in which the processing task is or includes digital predistortion, the linear regression data may be based on a GMP model, as described by Equation (1) above.

At operation 604, the model training system may generate modified linear regression data based on the linear regression data. The modified linear regression data may describe the processing task based on the target vector, the measurement vector, the weight vector, and a binary constraint vector. The binary constraint vector may be a binary vector describing at least one hardware constraint of the hardware component for executing the processing task. At operation 606, the model training system may generate relaxed linear regression data. The relaxed linear regression data may include a relaxed constraint vector based on the binary constraint vector. For example, the binary constraint vector may have vector values of either zero or one. On the other hand, the relaxed constraint vector may have vector values between and including zero and one. In some examples, this may result in a mixed integer formulation of the linear regression.

At operation 608, the model training system may apply a convex solver to the relaxed modified linear regression data generated at operation 606. The result may be a linear regression model of the processing task including, for example, a set of values for the constraint vector. The constraint vector generated at operation 608 may be a continuous constraint vector with values between zero and one. The continuous constraint vector may be projected to a binary constraint vector using any suitable techniques such as, for example, randomization, rounding, and/or the like. Also, in some examples, the constraint vector generated by the convex solver algorithm may be binary or nearly binary such that projection to binary is not performed. At operation 610, the generated model may be used to configure the hardware component and/or may be used to execute the processing task using the hardware component.

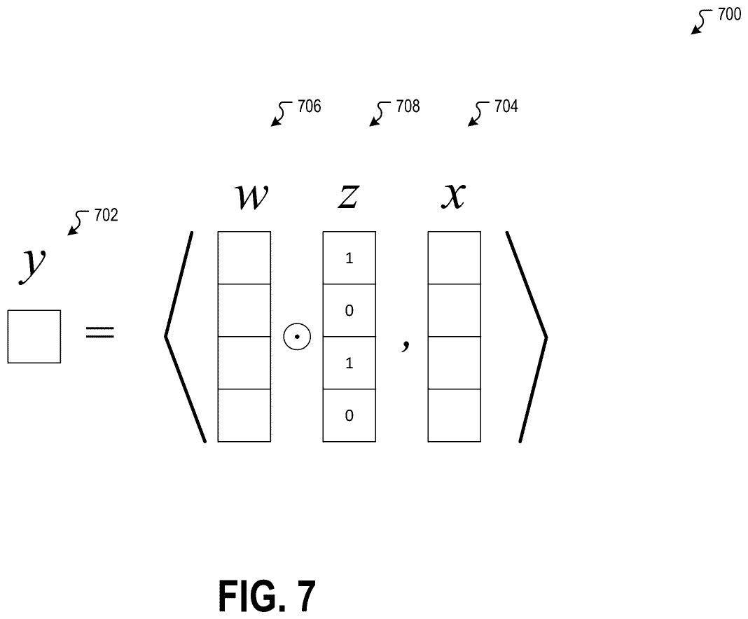

FIG. 7 is a diagram 700 showing one example form of linear regression data describing a processing task. The diagram 700 shows one example arrangement of the linear regression data that may be accessed at operation 602 of the process flow 600. In this example, y 702 is a target vector. In this example, the target vector y 702 comprises a single value representing the target vector y 702 at a single point in time. Over time, the target vector y 702 may comprise multiple values. The target vector y 702 is the sum of a vector multiplication of a measurement vector x 704 and the element-wise product of a weight vector w 706 and a binary constraint vector z. The linear regression data depicted by FIG. 7 can also be arranged in the form given by Equation (3) below:

$$y = ( w ⊙ z ) * {x}^{T} \qquad ( 3 )$$

The linear regression data may be used to perform a linear regression task. For example, multiple measurements of values from the target vector and measurement vector (xᵢ, yᵢ) may be used to recover values of the weight vector w. Recovered values of the weight vector w may, in turn, be used in conjunction with measured values of the measurement vector x to determine values of the target vector y. An example representation of such a linear regression problem is given by Equation (4):

$${\sum }_{i} {‖ {y}_{i} - {x}_{i}^{T} w ‖}_{2}^{2} \qquad ( 4 )$$

A representation of Equation (4) in matrix form is given by Equation (5) below:

$${min}_{w ∈ {ℝ}^{m}} {‖ Y - Xw ‖}_{2}^{2} + λ {‖ w ‖}_{2}^{2} \qquad ( 5 )$$

The matrix expression of Equation (5) adds a regularization term given by λ. The regularization term λ may be added for numerical stability and to consider multi-colinnearity, such as ridge regression. A closed form solution of Equation (5) is given by Equation (6) below:

$$w = {( {X}^{T} X + λ I )}^{- 1} {X}^{T} y \qquad ( 6 )$$

In various examples herein, the solution to linear regression problems such as the example of Equations (3)-(6) is hardware constrained. For example, not all of the values of the weight vector w and/or the measurement vector x may be available. For example, the hardware system implementing the linear regression may not include sufficient memory to store each value and/or may lack sufficient processing capacity to efficiently determine each value. Such a hardware limitation may be modeled with a structured sparsity S, which may be arranged as in Expression (7) below.

$$Supp ( w ) ∈ S ⊂ {2}^{m} \qquad ( 7 )$$

In this example, there are 2^{m} possible access patterns of the weight vector w, with the possible access patterns representing hardware limitation. In some examples, the weight vector w may be a 2-sparse 3-dimensional vector given by Expression (8):

$${‖ w ‖}_{0} = 2 \qquad ( 8 )$$

As described herein, a DPD algorithms, such as the GMP model, may be expressed as a linear regression problem. Consider the formulation of the Volterra series or a GMP model given by Equation (9) below:

$$z [ n ] = {\sum }_{i , j , k} {c}_{i , j , k} {\vert x [ n - i - {I}_{s} ] \vert}^{k} x [ n - j - {J}_{s} ] \qquad ( 9 )$$

The expression described by Equation (9) may be equivalent to the expression described by Equation (1) herein. For example, in Equation (9), the function fₖ is represented by various magnitudes of x raised to the k, |x[n−i−Iₛ]|k. In this example, the term c_{i,j,k} may be modeled as the three-dimensional weight vector w and the term |x[n−j−Jₛ]|^{k}x[n−i−Iₛ] may be modeled as the three-dimensional measurement vector x, where the measurement vector x includes DPD coefficients values. Solving the Volterra series subject to hardware constraints may include finding a feasible access pattern such that |{(i,j,k)}| are less than or equal to a number of coefficients, |{(i,j)}| are or less than a total number of lookup tables, {(i,j)} are a subset of a maximum allowable number of lookup tables [I, J], J s is a value of a vector [0, . . . , Jm] and Is is an value of [0, . . . , Im]. In a 16-bit arrangement, this may lead to about 1.06×10¹⁸³ possible access patterns. Future arrangements with higher bit components will have an even larger number of possible access patterns.

In various examples, a hardware-constrained linear regression problem, such as the DPD problem described above, may be expressed as a min-max problem. For example, the linear regression problem given by Equations (3)-(6) above may be expressed in the form given by Equation (10) according to the condition of Expression (7) such that w obeys a structured sparsity described by Expression (7):

$${min}_{w ∈ {ℝ}^{m}} \frac{1}{2} {\sum }_{i} {‖ {y}_{i} - {x}_{i}^{T} w ‖}_{2}^{2} + \frac{λ}{2} {‖ w ‖}_{2}^{2} \qquad ( 10 )$$

The structured sparsity condition can also be represented as a binary constraint vector z as shown in Equation (11) and used in Equation (3):

$$w = z ⊙ w = D ( z ) w \qquad ( 11 )$$

An example expression of Equation (11) is given by Equation (12) below where, from left to right, the first and third vectors represents example values for a weight vector w and the second vector represents example values for the binary constraint vector z, which may encode constraints as described herein. D(z) is a is a mathematical operation that facilitates imposition of the structured sparsity represented by z on the weight matrix w by matrix multiplication instead of an element-wise vector-vector multiplication.

$$[ \begin{matrix}1 \\ 0 \\ 3\end{matrix} ] = [ \begin{matrix}1 \\ 0 \\ 1\end{matrix} ] ⊙ [ \begin{matrix}1 \\ 0 \\ 3\end{matrix} ] \qquad ( 12 )$$

Incorporating the structured sparsity function D(z) described by Equations (11) and (12) into the expression of the linear regression given in mixed-integer form by Equation (10) yields Equation (13) below:

$${min}_{w ∈ {ℝ}^{m} , z ∈ {\{ 0 , 1 \}}^{m}} \frac{1}{2} {\sum }_{i} {‖ {y}_{i} - {x}_{i}^{T} D ( z ) w ‖}_{2}^{2} + \frac{λ}{2} {‖ D ( z ) w ‖}_{2}^{2} \qquad ( 13 )$$

Equation (13) may be simplified as given by Equation (14) by assuming that the first i value of the weight vector w is zero.

$${min}_{w ∈ {ℝ}^{m} , z ∈ {\{ 0 , 1 \}}^{m}} \frac{1}{2} {\sum }_{i} {‖ {y}_{i} - {x}_{i}^{T} D ( z ) w ‖}_{2}^{2} + \frac{λ}{2} {‖ w ‖}_{2}^{2} \qquad ( 14 )$$

The form given by Equation (14) may be expressed in vector form as a nested (e.g., bi-level) minimization problem in the form given by Equation (15):

$${min}_{z ∈ {\{ 0 , 1 \}}^{m}} {min}_{w ∈ {ℝ}^{m}} \frac{1}{2} {‖ y - XD ( z ) w ‖}_{2}^{2} + \frac{λ}{2} {‖ w ‖}_{2}^{2} \qquad ( 15 )$$

From the form given by Equation (15), the mixed-integer representation of the linear regression problem may be re-formulated into a convex Boolean form such as, for example, a min-max form or a matrix-fractional form. For example, to generate a min-max form, Equation (15) may be modified by taking the dual of the inner minimization problem as given by Equation (16):

$${min}_{z ∈ {\{ 0 , 1 \}}^{m}} {max}_{α ∈ {ℝ}^{n}} - \frac{1}{2} {‖ α ‖}_{2}^{2} + {α}^{T} y - \frac{1}{2 λ} {\sum }_{j} {z}_{j} {α}^{T} {X}_{j} {X}_{j}^{T} α \qquad ( 16 )$$

An example matrix-fractional form may be found by plugging the closed-form solution of the inner minimization problem into Equation (15)), yielding Equation (17):

$${min}_{z ∈ {\{ 0 , 1 \}}^{m}} \frac{1}{2} {{y}^{T} ( {J}_{n} + \frac{1}{λ} XD ( z ) {X}^{T} )}^{- 1} y \qquad ( 17 )$$

In the example of Equations (16) and (17), the respective operations are taken over the discrete range given by z∈{0,1}^{m}. In various examples, the mixed integer representation may be relaxed. For example, the respective operations may be taken over the continuous range z∈[0,1]^{m}, as given by Equations (18) and (19), with Equation (18) showing a relaxed min-max mixed integer representation and Equation (19) showing a relaxed matrix-fractional mixed integer representation:

$${min}_{z ∈ {[ 0 , 1 ]}^{m}} {max}_{α ∈ {ℝ}^{n}} - \frac{1}{2} {‖ α ‖}_{2}^{2} + {α}^{T} y - \frac{1}{2 λ} {\sum }_{j} {z}_{j} {α}^{T} {X}_{j} {X}_{j}^{T} α \qquad ( 18 )$$

$${min}_{z ∈ {[ 0 , 1 ]}^{m}} \frac{1}{2} {{y}^{T} ( {I}_{n} + \frac{1}{λ} XD ( z ) {X}^{T} )}^{- 1} y \qquad ( 19 )$$

Relaxing the mixed-integer representation of the linear regression allows values of the binary constraint vector z to take any value between 0 and 1. In practice, however, a memory value is either accessible or inaccessible. Accordingly, after finding the binary constraint vector z based on relaxing the mixed-integer representation of the linear regression, a screening may be applied. For example, the selected access pattern may be determined as given by Equation (20):

$${max}_{z ∈ {[ 0 , 1 ]}^{m}} {\sum }_{j} {z}_{j} {w}_{j} \qquad ( 20 )$$

For example, if there is one unique maximum of the weight vector w, zⱼ may be found as indicated by Equation (21):

$${z}_{j} = \{ \begin{matrix}1 , & j = arg max ( w ) \\ 0. & otherwise\end{matrix} . \qquad ( 21 )$$

If there are p duplicates of the maximum of the weight vector w, zⱼ may be found as indicated by Equation (22):

$${z}_{j} = \{ \begin{matrix}1 / p , & j ∈ arg max ( w ) \\ 0. & otherwise\end{matrix} . \qquad ( 22 )$$

If a distinct value of the weight matrix w cannot be found, a suitable scheme may be used to determine a distinct value. Example schemes for selecting a distinct value of the weight matrix w include, for example, a tie-breaking a randomized rounding scheme, and/or the like such that the structured sparsity constraints expressed by the values of z are satisfied.

The relaxed linear regression data may be used to solve the linear regression using, for example, a convex solver algorithm. The result of applying the convex solver algorithm may be a set of values for the weight vector and a set of values for the binary constraint vector. The determined set of values for the weight vector and a binary constraint vector may be used to program a hardware component to execute the processing task described by the linear regression such as, for example, digital predistortion.

Consider the example min-max relaxed linear regression data described by Equation (18) above. The terms of Equation (18) inside the minimum and maximum may be represented as a function h(z,α). In some examples, the representation of Equation (18) is convex in z for all α and concave in α for all z. Accordingly, the representation of Equation (18) may satisfy the minimax theorem, and therefore meet the following conditions given by Equation (23):

$${min}_{z} {max}_{α} h ( z , α ) = {max}_{α} {min}_{z} h ( z , α ) \qquad ( 23 )$$

$${z}^{*} ∈ arg min h ( z , {α}^{*} ) , {α}^{*} ∈ arg min h ( {z}^{*} , α )$$

The regression may be solved using various different convex solver algorithms such as, for example, a dual sub-gradient approach, or a game-theoretic algorithm, such as an online learning-game theory algorithm, and/or the like. In various examples, the solution may meet the conditions given by Expression (24) below:

$$For t in 1 … T : \qquad ( 24 )$$

$${z}^{t} ∈ arg min h ( z , {α}^{t - 1} )$$

$${α}^{t} ∈ arg min h ( {z}^{t} , α )$$

$${z}^{*} ∈ arg min h ( z , \overline{α} ) , \overline{α} = average ( {α}_{1} , {α}_{2} , … , {α}_{T} )$$

Also consider the relaxed matrix-fractional mixed integer representation of the relaxed linear regression data given by Equation (19) above. The representation given by Equation (19) may also be expressed as shown in Equation (25) below:

$${min}_{z ∈ {\{ 0 , 1 \}}^{m}} \frac{1}{2} {y}^{T} {Q}^{- 1} y \qquad ( 25 )$$

In this example, Q is an invertible matrix. In this example, Q is the sum of positive semi-definite matrices, so Q>0. The Schur complement may be given by Equation (26) below:

$$A = [ \begin{matrix}Q & y \\ {y}^{T} & t\end{matrix} ] \qquad ( 26 )$$

$$If Q ≽ 0 : t \geq {y}^{T} {Q}^{- 1} y ⇔ A ≽ 0$$

The expression given by Equation (26) may be solved using a convex solver algorithm such as, for example, a semidefinite programming (SD P) solver, or projected sub-gradient descent. An example projected sub-gradient descent technique is described by Expression (27):

$$For t in 1 … T : \qquad ( 27 )$$

$${g}^{t} ∈ subgradient [ {{y}^{T} ( {I}_{n} + \frac{1}{λ} XD ( {z}^{t} ) {X}^{T} )}^{- 1} y$$

$${z}^{t + 1} = project ( {z}^{t} - ϵ {g}^{t} )$$

In Equation (27), ‘project’ maps the updated value of z to be in {0,1} satisfying the structured sparsity described herein.

FIG. 8 is a block diagram of an example machine 800 upon which any one or more of the techniques (e.g., methodologies) discussed herein may be performed. In alternative examples, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in a peer-to-peer (P2P) (or other distributed) network environment. The machine 800 may be a personal computer (PC), a tablet PC, a set-top box (STB), a personal digital assistant (PDA), a mobile telephone, a web appliance, an IoT device, an automotive system, an aerospace system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as via cloud computing, software as a service (Saas), or other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant-massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 800 may include a hardware processing unit 802 (e.g., a central processing unit (CPU), a graphics processing unit (GPU), a hardware processor core, or any combination thereof, such as a memory controller, etc.), a main memory 804, and a static memory 806, some or all of which may communicate with each other via an interlink (e.g., bus) 808. The machine 800 may further include a display device 810, an alphanumeric input device 812 (e.g., a keyboard), and a user interface (UI) navigation device 814 (e.g., a mouse). In an example, the display device 810, alphanumeric input device 812, and UI navigation device 814 may be a touchscreen display. The machine 800 may additionally include a storage device 822 (e.g., drive unit); a signal generation device 818 (e.g., a speaker); a network interface device 820; one or more sensors 816, such as a Global Positioning System (GPS) sensor, wing sensor, mechanical device sensor, temperature sensor, bridge sensor, audio sensor, industrial sensor, a compass, an accelerometer, or other sensors; and one or more system-in-package data acquisition devices 890. The system-in-package data acquisition device(s) 890 may implement some or all of the functionality of the electrolyzer systems, discussed above. The machine 800 may include an output controller 828, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The storage device 822 may include a machine-readable medium on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processing unit 802 during execution thereof by the machine 800. In an example, one or any combination of the hardware processing unit 802, the main memory 804, the static memory 806, or the storage device 822 may constitute the machine-readable medium.

While the machine-readable medium is illustrated as a single medium, the term “machine-readable medium” may include a single medium or multiple media (e.g., a centralized or distributed database, or associated caches and servers) configured to store the one or more instructions 824.

The term “machine-readable medium” may include any transitory or non-transitory medium that is capable of storing, encoding, or carrying transitory or non-transitory instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 (e.g., software, programs, an operating system (OS), etc.) or other data that are stored on the storage device 821 can be accessed by the main memory 804 for use by the hardware processing unit 802. The main memory 804 (e.g., DRAM) is typically fast, but volatile, and thus a different type of storage from the storage device 821 (e.g., an SSD), which is suitable for long-term storage, including while in an “off” condition. The instructions 824 or data in use by a user or the machine 800 are typically loaded in the main memory 804 for use by the hardware processing unit 802. When the main memory 804 is full, virtual space from the storage device 821 can be allocated to supplement the main memory 804; however, because the storage device 821 is typically slower than the main memory 804, and write speeds are typically at least twice as slow as read speeds, use of virtual memory can greatly reduce user experience due to storage device latency (in contrast to the main memory 804, e.g., DRAM). Further, use of the storage device 821 for virtual memory can greatly reduce the usable lifespan of the storage device 821.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone Service (POTS) networks, and wireless data networks (e.g., Institute of Electrical and Electronics Engineers (IEEE) 802.11 family of standards known as Wi-Fi®, IEEE 802.16 family of standards known as WiMax®, IEEE 802.15.4 family of standards, P2P networks), among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any tangible or intangible medium that is capable of storing, encoding, or carrying instructions for execution by the machine 800, and includes digital or analog communications signals or other tangible or intangible media to facilitate communication of such software.

Each of the non-limiting examples or examples described herein may stand on its own, or may be combined in various permutations or combinations with one or more of the other examples.

The above detailed description includes references to the accompanying drawings, which form a part of the detailed description. The drawings show, by way of illustration, specific examples in which the inventive subject matter may be practiced. These examples are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more examples thereof), either with respect to a particular example (or one or more examples thereof), or with respect to other examples (or one or more examples thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following examples, the terms “including” and “comprising” are open-ended; that is, a system, device, article, composition, formulation, or process that includes elements in addition to those listed after such a term in an aspect are still deemed to fall within the scope of that aspect. Moreover, in the following examples, the terms “first,” “second,” “third,” and so forth are used merely as labels and are not intended to impose numerical requirements on their objects.

Method examples described herein may be machine- or computer-implemented at least in part. Some examples may include a computer-readable medium or machine-readable medium encoded with transitory or non-transitory instructions operable to configure an electronic device to perform methods as described in the above examples. An implementation of such methods may include code, such as microcode, assembly-language code, a higher-level-language code, or the like. Such code may include transitory or non-transitory computer-readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAM s), read-only memories (ROM s), and the like.

The above description is intended to be illustrative, and not restrictive. For example, the above-described examples (or one or more examples thereof) may be used in combination with each other. Other examples may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above detailed description, various features may be grouped together to streamline the disclosure. This should not be interpreted as intending that a disclosed feature not listed in the list of claims is essential to any aspect. Rather, inventive subject matter may lie in less than all features of a particular disclosed example. Thus, the following examples are hereby incorporated into the detailed description as examples or examples, with each claim standing on its own as a separate example, and it is contemplated that such examples may be combined with each other in various combinations or permutations. The scope of the inventive subject matter should be determined with reference to the appended claims, along with the full scope of equivalents to which such claims are entitled.

1. A system determining a linear regression model for executing a processing task, the system comprising:
at least one hardware processing unit programmed to perform operations comprising:
accessing linear regression data describing the processing task to be performed by a hardware component, the linear regression data describing the processing task based on a target vector describing an output of the hardware component, a measurement vector describing measurements on which the output of the hardware component is based, and a weight vector describing weights applied to the measurement vector to generate the target vector;
generating modified linear regression data based on the linear regression data, the modified linear regression data describing the processing task based on the target vector, the measurement vector, the weight vector, and a binary constraint vector, the binary constraint vector describing a hardware constraint limiting access by the hardware component to at least a portion of the weight vector;
generating relaxed linear regression data based on the modified linear regression data, the relaxed linear regression data describing the processing task based on the target vector, the measurement vector, the weight vector, and a relaxed constraint vector, the relaxed constraint vector being based at least in part on the binary constraint vector;
executing a convex solver algorithm using the relaxed linear regression data to determine a set of values for the weight vector and a set of values for the binary constraint vector; and
programming the hardware component to execute the processing task using the set of values for the weight vector.

2. The system of claim 1, the operations further comprising executing the processing task using the hardware component.

3. The system of claim 1, the processing task comprising digital predistortion of an input signal.

4. The system of claim 1, the generating of the modified linear regression data comprising generating a min-max representation of the measurement vector, the weight vector, and the binary constraint vector.

5. The system of claim 1, the convex solver algorithm comprising at least one of a dual sub-gradient algorithm or a game-theoretic algorithm.

6. The system of claim 1, the generating of the modified linear regression data comprising generating a matrix-fractional representation of the measurement vector, the weight vector, and the binary constraint vector.

7. The system of claim 1, the executing of the convex solver algorithm comprising executing a projected sub-gradient descent algorithm.

8. A method of arranging a hardware component to implement a processing task, the method comprising:
accessing linear regression data describing the processing task to be performed by the hardware component, the linear regression data describing the processing task based on a target vector describing an output of the hardware component, a measurement vector describing measurements on which the output of the hardware component is based, and a weight vector describing weights applied to the measurement vector to generate the target vector;
generating modified linear regression data based on the linear regression data, the modified linear regression data describing the processing task based on the target vector, the measurement vector, the weight vector, and a binary constraint vector, the binary constraint vector describing a hardware constraint limiting access by the hardware component to at least a portion of the weight vector;
generating relaxed linear regression data based on the modified linear regression data, the relaxed linear regression data describing the processing task based on the target vector, the measurement vector, the weight vector, and a relaxed constraint vector, the relaxed constraint vector being based at least in part on the binary constraint vector;
executing a convex solver algorithm using the relaxed linear regression data to determine a set of values for the weight vector and a set of values for the binary constraint vector; and
programming the hardware component to execute the processing task using the set of values for the weight vector.

9. The method of claim 8, further comprising executing the processing task using the hardware component.

10. The method of claim 8, the processing task comprising digital predistortion of an input signal.

11. The method of claim 8, the generating of the modified linear regression data comprising generating a min-max representation of the measurement vector, the weight vector, and the binary constraint vector.

12. The method of claim 8, the convex solver algorithm comprising at least one of a dual sub-gradient algorithm or a game-theoretic algorithm.

13. The method of claim 8, the generating of the modified linear regression data comprising generating a matrix-fractional representation of the measurement vector, the weight vector, and the binary constraint vector.

14. The method of claim 8, the executing of the convex solver algorithm comprising executing a projected sub-gradient descent algorithm.

15. A non-transitory computer-readable medium comprising instructions thereon that, when executed by at least one hardware processing unit, cause the at least one hardware processing unit to perform operations comprising:
accessing linear regression data describing a processing task to be performed by a hardware component, the linear regression data describing the processing task based on a target vector describing an output of the hardware component, a measurement vector describing measurements on which the output of the hardware component is based, and a weight vector describing weights applied to the measurement vector to generate the target vector;
generating modified linear regression data based on the linear regression data, the modified linear regression data describing the processing task based on the target vector, the measurement vector, the weight vector, and a binary constraint vector, the binary constraint vector describing a hardware constraint limiting access by the hardware component to at least a portion of the weight vector;
generating relaxed linear regression data based on the modified linear regression data, the relaxed linear regression data describing the processing task based on the target vector, the measurement vector, the weight vector, and a relaxed constraint vector, the relaxed constraint vector being based at least in part on the binary constraint vector;
executing a convex solver algorithm using the relaxed linear regression data to determine a set of values for the weight vector and a set of values for the binary constraint vector; and
programming the hardware component to execute the processing task using the set of values for the weight vector.

16. The non-transitory computer-readable medium of claim 15, the processing task comprising digital predistortion of an input signal.

17. The non-transitory computer-readable medium of claim 15, the generating of the modified linear regression data comprising generating a min-max representation of the measurement vector, the weight vector, and the binary constraint vector.

18. The non-transitory computer-readable medium of claim 15, the generating of the modified linear regression data comprising generating a min-max representation of the measurement vector, the weight vector, and the binary constraint vector.

19. The non-transitory computer-readable medium of claim 15, the convex solver algorithm comprising at least one of a dual sub-gradient algorithm or a game-theoretic algorithm.

20. The non-transitory computer-readable medium of claim 15, the generating of the modified linear regression data comprising generating a matrix-fractional representation of the measurement vector, the weight vector, and the binary constraint vector.
